(19) United States
(12) Patent Application Publication
(10) Pub. No.: US 2025/0206096 A1
(43) Pub. Date: Jun. 26, 2025

(54) Overrunable Test Vehicle

(71) Applicant: Humanetics Austria GmbH, Linz (AT)

(72) Inventors: Philipp Kroiss, Bad Hall (AT); Lukas Ruhs, Linz (AT)

(21) Appl. No.: 18/390,077

(22) Filed: Dec. 20, 2023

(51) Int. Cl. B60G 17/017; B60G 7/00; B60G 17/02

(52) U.S. Cl. CPC B60G 17/017; B60G 7/001; B60G 7/008; B60G 17/021; B60G 7/04

(57) ABSTRACT

An overrunable test vehicle includes a chassis, a wheel operatively attached to the chassis, and a suspension system. The suspension system includes a pivot arm mounted to the chassis about a pivot axis, and the wheel rotatably mounted to the pivot arm. The suspension system also includes a first biasing element having a first spring rate. The first biasing element is partially supported by the chassis and arranged to engage the pivot arm to provide a first suspension force in a first direction about the pivot axis. The suspension system further includes a second biasing element having a second spring rate, different than the first spring rate. The second biasing element is at least partially supported by the chassis and arranged to engage the pivot arm to provide a second suspension force in a second direction about the pivot axis, opposite the first direction.

### BACKGROUND

With the rise of Advanced Driver Assistant Systems (ADAS) being developed and tested, the need for testing equipment which reduces risk to testing members, while being able to sustain potentially damaging impacts and scenarios has drastically increased. A paramount tool in testing the developing crash avoidance technologies is the use of mobile and controllable platforms, sometimes known as an overrunable test vehicle. The mobile platforms are adapted to hold simulated target objects known as ‘soft targets’ and can be in the form of an automobile, truck, pedestrian, bicycle, or similar. The simulated target is typically made of a material which will not damage the vehicle equipped with the ADAS, such as foam, cardboard, or any other soft material.

During testing, different soft targets may be employed in different scenarios to obtain different data from the ADAS systems. Depending on the soft target, different mobile test platforms may be used in order to better simulate the particular test scenario to test certain features of the crash avoidance technologies integrated into passenger vehicles.

One challenge with overrunable test vehicles lies in equipping the overrunable test vehicle with a suspension system that provides both the desired damping characteristics, as well as the necessary durability to withstand the significant force of being overrun by a vehicle such as an automobile or truck. Accordingly, there is a need in the art to solve one or more of these challenges.

### SUMMARY

The present disclosure is generally directed to an overrunable test vehicle configured to carry a soft target. The overrunable test vehicle includes a chassis, a wheel operatively attached to the chassis, and a suspension system to allow relative movement between the wheel and the chassis. The suspension system includes a pivot arm extending between a first portion and a second portion. The pivot arm pivotally is mounted to the chassis between the first and second portions about a pivot axis, and the wheel rotatably mounted to the first portion about a wheel axis. The suspension system also includes a first biasing element having a first spring rate. The first biasing element is partially supported by the chassis and arranged to engage the first portion of the pivot arm to provide a first suspension force in a first direction about the pivot axis. The suspension system further includes a second biasing element having a second spring rate, different than the first spring rate. The second biasing element is at least partially supported by the chassis and arranged to engage the second portion of the pivot arm to provide a second suspension force in a second direction about the pivot axis, opposite the first direction.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a perspective view of a prior art overrunable test vehicle with a soft target being struck by a vehicle.

FIG. 2 is a perspective view of a prior art overrunable test vehicle and pedestrian soft target.

FIG. 3 is a perspective view of an overrunable test vehicle according to the present invention.

FIG. 4 is a side view of the overrunable test vehicle.

FIG. 5 is a bottom perspective view of the overrunable test vehicle.

FIG. 6 is a schematic top view of the overrunable test vehicle with the top surface hidden.

FIG. 7 is a bottom view of the overrunable test vehicle.

FIG. 8 is atop perspective view of the overrunable test vehicle.

FIG. 9 is a cross-sectional representation of a suspension system of the overrunable test vehicle with the chassis shown in phantom.

FIGS. 10A and 10B are various perspective exploded views of the suspension system of the overrunable test vehicle.

FIGS. 11A through 11C are cross-sectional representations illustrating a plurality of suspension states of suspension system of the overrunable test vehicle.

FIG. 12 is a cross-sectional representation illustrating a service state of suspension system of the overrunable test vehicle.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

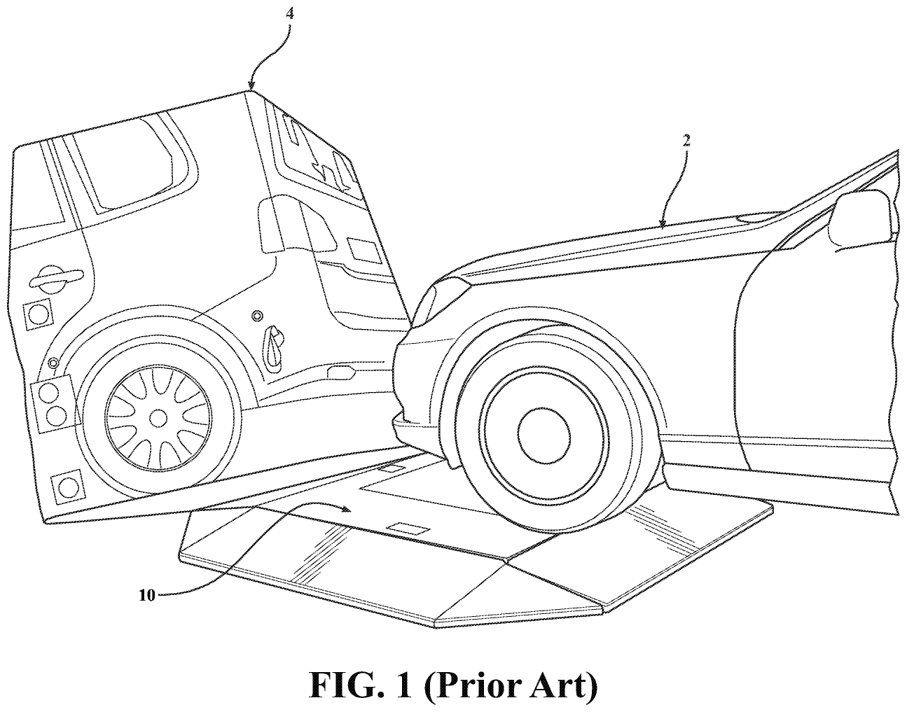

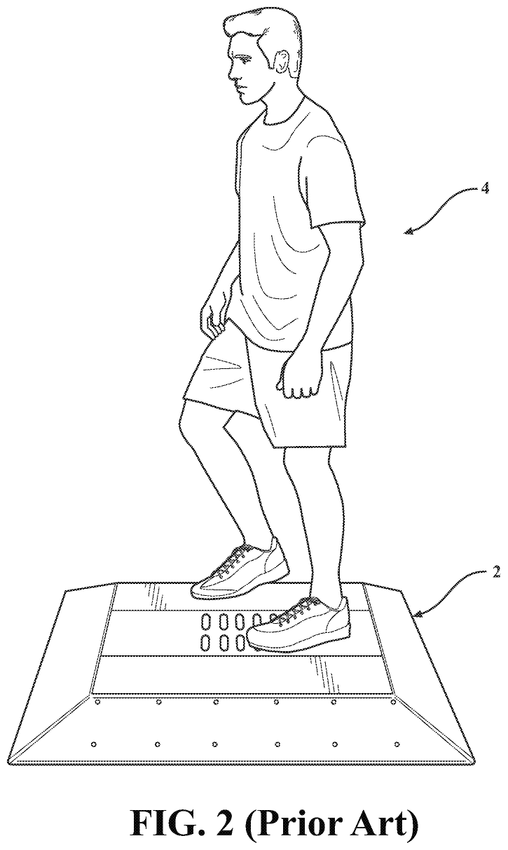

The present teachings relate to an overrunable test vehicle 10 for testing advanced crash avoidance technologies. FIGS. 1 and 2 show prior art examples of such an overrunable test vehicle 2. The overrunable test vehicle 2 may function as a mobile and controllable platform for holding a simulated target object 4 (i.e., soft target 4) such as an automobile, truck, pedestrian, bicycle, or similar. FIG. 1 shows one example of a large overrunable test vehicle 2 configured to carry a soft target 4 representing a vehicle. FIG. 2 shows an overrunable test vehicle 2 with a pedestrian soft target 4.

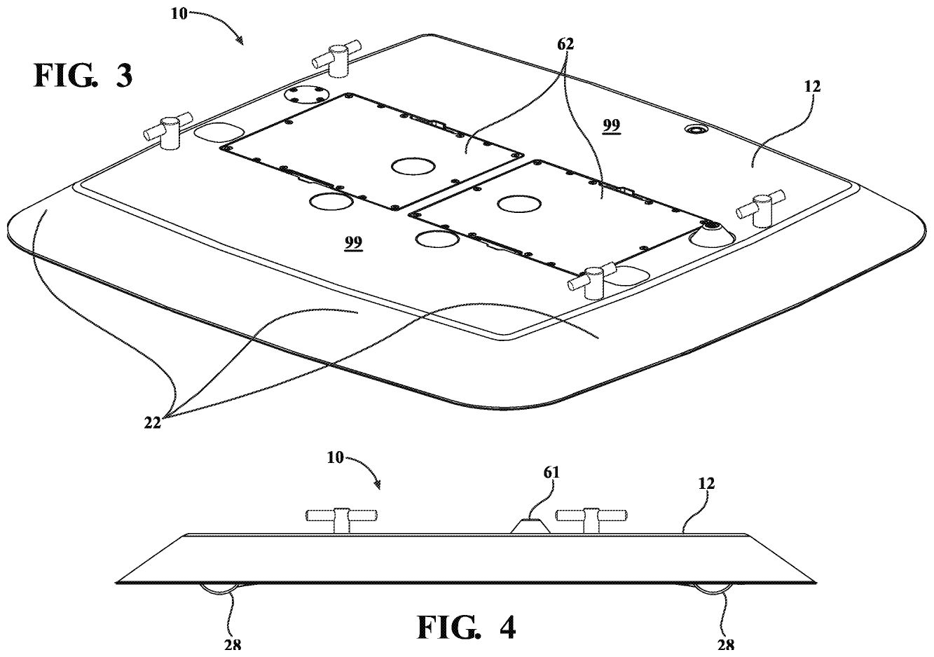

FIG. 3-12 illustrate an overrunable test vehicle 10 according to the present invention. The test vehicle 10 is an overrunable test vehicle 10 (herein referred to as OTV 10). During testing of advanced crash avoidance technologies, the OTV 10 may be subjected to rigorous conditions, including be run over by a vehicle with advanced crash avoidance technologies. The OTV 10 may be configured to withstand the weight of such a vehicle. For example, the OTV 10 may be able to withstand a passenger car of 3.5 tons. The OTV 10 may be configured to hold 4 tons per wheel. The OTV 10 may be configured to hold an automobile consistent with category Ml of the EU vehicle definitions (https://www.transportpolicy.net/standard/eu-vehicle-definitions/). In some examples, the OTV 10 may be configured to move a soft target with a weight of 5 kilograms (kg) or more, 10 kg or more, 20 kg or more, 50 kg or more, or even 75 kg or more. In some examples, the OTV 10 may be able to move the one or more soft targets to a speed of 80 kph or more. In some examples, the OTV 10 may have a different top speed loaded than when the OTV 10 is free from a soft target. In some examples, the OTV may have a top speed of over 100 kph when loaded with a soft target weighing between 10 kg and 50 kg or more.

Turning to FIGS. 3 and 4, the OTV 10 includes a chassis 12. The chassis 12 functions as the base structure of the OTV 10. The chassis 12 may be made of steel, composite material, aluminum, plastic, or a combination thereof. In some examples, the chassis 12 may be a unitary component. In some examples, the chassis 12 is made from a single block of machined aluminum. In other examples, the chassis 12 is made of two or more modular components. The chassis 12 may be divided into several sections corresponding with certain features of the OTV 10, such as separate compartments to house the different systems and components of the OTV 10. The chassis 12 may have a generally geometric shape. For example, the chassis 12 may have a shape such as rectangular, square, circular, triangular, polygonal or the like. The chassis 12 may have an overall length of 200 cm or less. In some examples, the chassis 12 has an overall length of 150 cm or less, or even 110 cm or less. In some examples, the chassis 12 may have a relatively consistent thickness. In other examples, the chassis 12 may have a varying thickness.

With continued reference to FIGS. 3 and 4, the chassis 12 may function to protect the control system(s) of the OTV 10, which are described in further detail below. In other words, the chassis 12 may function to allow a vehicle ride over the top of the OTV 10 without damaging the components within the chassis 12. The chassis 12 may include one or more battery housings 63 with covers 62 for locating one or more batteries 82 within the chassis 12 of the OTV 10. The batteries 82 may be located in a battery housing 63 within the chassis 12 and include a battery lid 62 which is flush with the top surface 99.

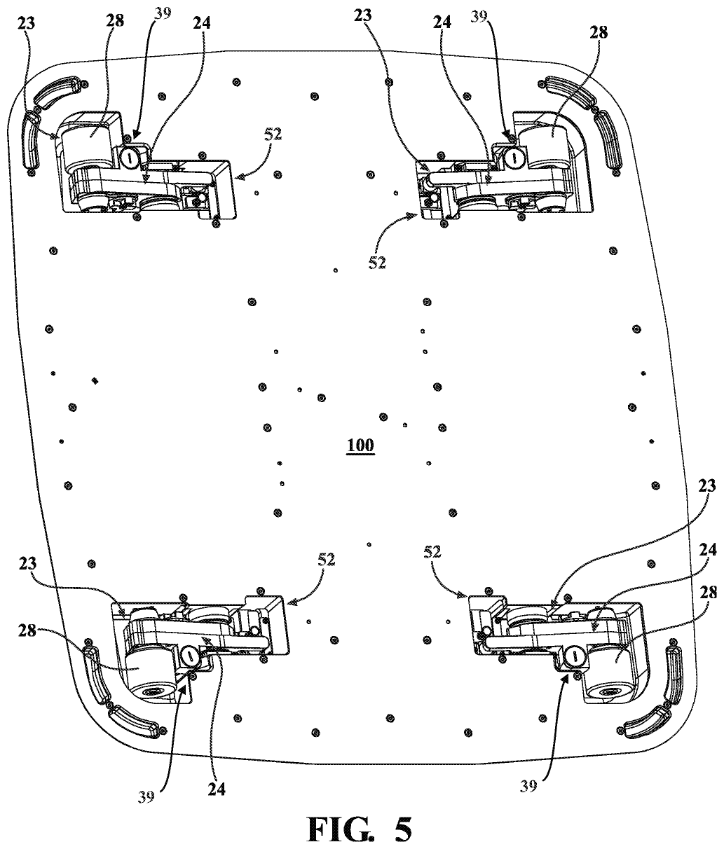

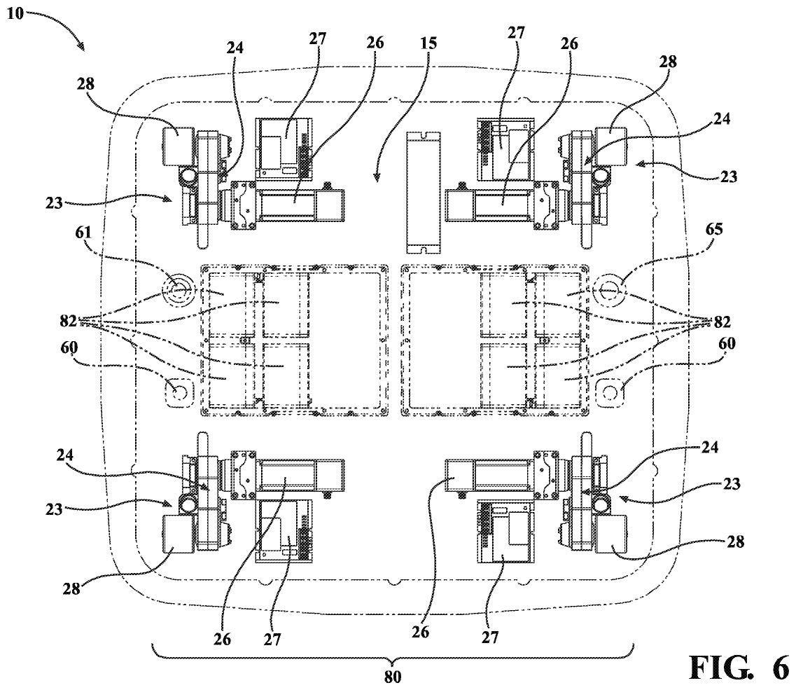

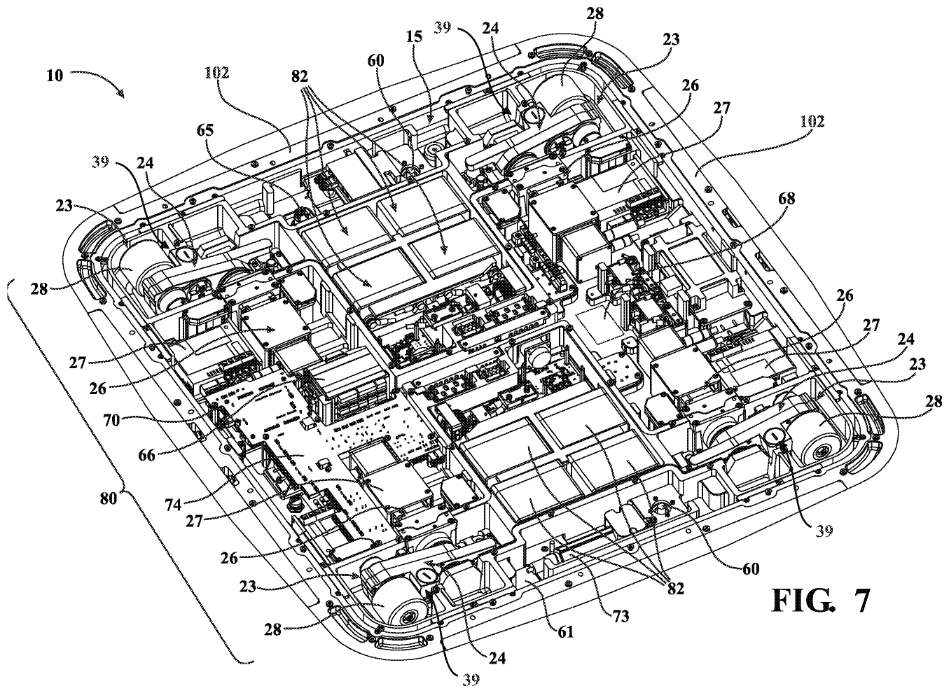

The chassis 12 may define an interior cavity 15, such as shown in FIGS. 6 and 7. The interior cavity 15 is an open space for mounting and positioning the different components of the OTV 10, such as the drive mechanisms 23, control system(s) 80, batteries 82, a plurality of sensors, antennas, receivers, or a combination thereof. The interior cavity 15 of the chassis 12 may be covered with a bottom cover 100 (shown in FIG. 5), battery covers 62, and/or a plurality of other covers or shields for protecting the components of the OTV 10 from being destroyed during testing.

The interior cavity 15 of the chassis 12 may be divided into separate compartments to house the different systems and components of the OTV 10. The compartments may function to separate mechanical systems, electrical systems, power systems, sensors, wheels, or a combination thereof from each other. The compartments may be sealed or unsealed. The compartments may be watertight. The chassis 12 may include two or more, three or more, four or more, eight or more, or even ten or more compartments. For example, the chassis 12 may be segmented into a plurality of compartments, separating the control system(s) 80 from the respective transaxle(s) 24, wheel(s) 28, and suspension system(s) 39 (described in further detail below). In some examples, the compartments housing each of the transaxle(s) 24, wheel(s) 28, and suspension system(s) 39 are the only compartments that are open to ambient (i.e., unsealed), with the control system 80, batteries 82, sensors, and electric motors 26 shielded behind one or more covers. In some examples, the OTV 10 has four electric motors 26 (e.g., one for each wheel 28). Here, each of the electric motors 26 may be in a separate compartment of the interior cavity 15.

The OTV 10 may include one or more batteries 82. The one or more batteries 82 may function to provide power to OTV 10. The OTV 10 may have one or more, two or more, three or more, four or more, or even a plurality of batteries 82. The one or more batteries 82 may be removably connected with the OTV 10. The one or more batteries 82 are connected with a power controller. In some examples, the one or more batteries 82 are integrated with the power controller. In some examples, there is one power controller for each battery. In other examples, the power controller and the one or more batteries 82 are separate. The one or more batteries 82 may provide the OTV 10 with one or more hours, two or more hours, three or more hours, or even four or more hours of operation. In some examples, the one or more batteries 82 may provide two hours of use, performing 20 or more tests while the OTV 10 is fully loaded. The one or more batteries 82 may power the motors 26 to move the OTV 10 to 100 or more kph. The one or more batteries 82 may power the motors 26 to provide constant speed for an extended period of time while testing. The one or more batteries 82 may swappable so that a user may quickly change to a charged battery to resume testing. The one or more batteries 82 may charge in two or less hours, one or less hours, or even half an hour or less. The one or more batteries 82 may be located in one or more compartments of the OTV 10. The one or more batteries 82 may be flush with the top surface 99 of the OTV 10 when installed in the OTV 10. In some examples, as shown in FIGS. 3 and 6, the one or more batteries 82 are stored within the chassis 12 and a battery cover 62 is disposed on the top surface of the OTV 10, concealing and sealing the one or more batteries 82. The battery cover 62 may be configured to “hot swap” the one or more batteries 82, meaning that the cover is configured to be unattached quickly so that the one or more batteries 82 that have been exhausted can be changed for a charged battery. The battery cover 62 may include a plurality of magnets and/or integrated quick-disconnect fasteners for connecting to the chassis 12.

FIGS. 5 and 7 illustrates a bottom view of the OTV 10 including the bottom cover 100. The chassis 12 may include the removable bottom cover 100 for sealing and protecting a substantial portion of the components within the interior cavity 15 of the OTV 10. The bottom cover 100 may be made of steel, composite material, plastic, or a combination thereof. The bottom cover 100 may cover portions of the chassis 12 which are hollow and house at least a portion of the control system 80, propulsion systems/drivetrain 23, sensors, or a combination thereof. The bottom cover 100 may be connected to the chassis 12 with a series of fasteners, for example, along the seal 102. The seal 102 keeps the components within the chassis 12 from being affected by road debris, fluid, or any other potential hazardous material which a OTV 10 may encounter during normal operation. The bottom cover 100 may include a plurality of pockets 52 configured to allow each of the drive mechanisms 23 to protrude from the interior cavity 15 to extend below the bottom cover 100 and contact the ground surface GS. As shown in FIG. 5, the pockets 52 may have a L-shape which allow the drive mechanisms 23 to move with changes in the ground surface GS relative to the bottom cover 100.

Briefly referring back to FIGS. 3 and 4, the OTV 10 may include a plurality of sidewalls 22 coupled to the chassis 12. The plurality of sidewalls 22 may be configured as ramping portions of the chassis 12. The plurality of sidewalls 22 function to assist a vehicle with Advanced Driver Assistant Systems (ADAS) technology run over the OTV 10 by allowing the tires of vehicle to climb over the OTV 10. The chassis 12 may include one or more, two or more, three or more, four or more, six or more, eight or more, ten or more sidewalls 22. The sidewalls 22 may be permanently connected with the chassis 12. The sidewalls 22 may be removably connected with the chassis 12. The OTV 10 may include at least one sidewall 22 for each side or portion of the OTV 10 so that the OTV 10 may be easily overrun on any side.

Referring to FIGS. 6-8, the OTV 10 may include a plurality of drive mechanisms 23. The drive mechanisms 23 are configured to accelerate and decelerate the OTV 10. The drive mechanisms 23 are located within the interior cavity 15 of the OTV 10. Each drive mechanism 23 may comprise a transaxle 24 including an electric motor 26 and a drive wheel 28. As described in further detail below, a suspension system 39 may be operatively attached to each drive mechanism 23 to allow relative movement of the drive wheel 28 relative to the chassis 12. In the illustrated examples, the OTV 10 includes four drive mechanisms 23, however; more or less drive mechanisms 23 are contemplated. The speed at which the OTV 10 travels is dependent on the load carried by the OTV 10, which, in most cases, will be a soft target 92. The drive mechanisms 23 may be configured to accelerate the OTV 10 at a rate 0.1 m/s2 and 5.0 m/s2 or more. The drive mechanisms 23 may be configured to assist the OTV 10 in decelerating and stopping at a rate ranging between −0.1 m/s2 and −5.0 m/s2 or more. In some examples, the rate of acceleration and deceleration is weight dependent. In one example, the OTV 10 is capable of accelerating at a rate of 2.0 m/s2 and decelerating at a rate of −2.0 m/s2 with a payload of 10 kg. Acceleration and deceleration are affected by the weight of the payload on the OTV 10 resulting in slower acceleration and deceleration when the weight of the soft target 92 is increased.

The OTV 10 may also include a control system 80 which may include a plurality of controllers, a plurality of sensors, or both working in unison and/or independently. In some examples, the control system 80 includes one or more on-board controllers, and one or more remote controllers. In some examples, the one or more on-board controllers work in conjunction with one or more remote controllers. A remote controller may be used to control one or more OTVs 10. The control system 80 may include a control board 74, a safety controller 66, inertial measurement unit 68, steering controller 70, communications controller 72, an onboard Wi-Fi module 73, GNSS antennas 60, motors 26, or a combination thereof. The control system 80 may also include a plurality of sensors such as a ground speed sensor, an inertial sensor, a force sensor, the like, or a combination thereof.

Referring to FIG. 7, the control system 80 may be housed within the interior cavity 15 of the chassis 12 of the OTV 10. As best shown in FIGS. 6 and 7, the control system 80 may include a control board 74, a safety controller 66, inertial measurement unit 68, steering controller 70, an onboard Wi-Fi module 73, global navigation satellite system (GNSS) antennas 60, maintenance port 65, motors 26, or a combination thereof. The plurality of sensors may be located within the one or more of the controllers 74, 66, 68, 70, 27, of the control system 80. The control system 80 may receive data from the plurality of sensors and controllers (e.g., ground speed sensor, GNSS antenna 60, motor 26, external controllers). The control system 80 may calculate the optimum acceleration parameters, deceleration parameters, or both based on the data received from the plurality of sensors. The control system 80 may utilize an algorithm which optimizes acceleration and deceleration without causing unnecessary or undesirable conditions.

The safety controller 66 are used to determine and maintain an appropriate performance level according by calculating an analysis of failure modes and effects, ensuring that the OTV operates as intended. For example, the safety controller 66 may prevent unintentional movement and determine appropriate conditions for the OTV 10 to emergency stop.

The inertial measurement unit 68 functions to monitor the speed and acceleration of the OTV 10 using GNSS, ground speed sensors, and inertial sensors, providing the data to the safety controller, the steering controller, the communications controller, or any part of the control system 80 necessary to control the OTV 10.

The GNSS antennas 60 are used to localize the OTV 10 and track the position of the OTV 10 during a test. In some examples, other forms of localizing the position of the OTV 10 may be used, such as ultraband receivers and beacons.

The maintenance port 65 are used to connect external equipment to the OTV 10 to gather data, adjust settings, or perform routine maintenance. The maintenance port 65 may be powered and may additionally function to provide a power source to a soft target 92. For example, a soft target 92 may be configured as a vehicle with headlights and taillights, and may be connected through a cable to the OTV 10 to provide power to the soft target 92, enabling the realistic light conditions on the soft target 92.

The steering controller 70 functions to control the steering of the OTV 10 through an algorithm based on speed, acceleration, power levels, location, and other attributes of the OTV 10 during operation. The communications controller 72 functions to link the control system 80 and any other external controllers together, serving as an on-board local area network. The communications controller 72 may be connected with the Wi-Fi module 73 and Wi-Fi antenna 61. In some examples, the Wi-Fi antenna 61 extend out of the chassis 12 past (i.e., above) the outer surface 99 to provide better connectivity and is configured to withstand being overrun by an automobile. The Wi-Fi antenna 61 may be removably connected to the chassis 12. The Wi-Fi antenna 61 may be a disposable part.

The control system 80 may be connected with the one or more motors 26, the one or more motor controllers 27, one or more remote controllers, or a combination thereof. The control system 80 may include the one or more motors 26, one or more motor controller(s) 27, or both. The control system 80 may send messages and/or commands relating to one or more motor parameters to the motor controller(s) 27 which controls the actuation of the motor(s) 26.

Motor parameters are one or more outputs of the motor(s) 26 which can be commanded by the motor controller(s) 27, the control system 80, or both. The motor parameters may include a motor speed, a motor torque, or both. The one or more motor parameters may be executed by delivering a specific electric current to the one or more motors 26. The amount of current applied to each electric motor 26 corresponds with an output torque which is then applied to the drive wheel 28. The amount of current applied to each electric motor 26 may correspond with a set RPM of the output of the electric motors 26. The control system 80 calculates and commands the current to the electric motors 26 required to achieve a designated wheel speed of the drive wheels 28, and, ultimately, the ground speed of the OTV 10.

The motor controller(s) 27 may communicate with the control system 80 through a controller area network (CAN) which sends data through the control system 80, controlling the operation of the OTV 10. For example, when a deceleration is commanded by the control system 80, the one or more electric motors 26 may receive a CAN command to slow the OTV 10 down to a desired rate by adjusting the motor speed, motor torque, or both. The control system 80 may function to control the amount of braking force used by the OTV 10 to decelerate and stop. The control system 80 may work in conjunction with the motor controller 27 to control the one or more motor parameters to slow down or stop the OTV 10 at a particular deceleration.

The control system 80 may receive data from the plurality of sensors and controllers (e.g., ground speed sensor, GNSS antenna 60, motor 26, external controllers). For example, the ground speed sensor may function to calculate the speed of the chassis 12. The ground speed sensor may be connected with the control system 80 and send the speed measurements, inertial measurements, or both to the controller 80 for processing. The ground speed sensor may be located on or in one or more of the plurality of controllers 66, 68, 70, 74 within the control system 80. The ground speed sensor may work in conjunction with or be a part of the GNSS antenna 60, to ascertain the ground speed of the chassis 12. The control system 80 may calculate the optimum acceleration parameters, deceleration parameters, or both based on the data received from the plurality of sensors. The control system 80 may utilize an algorithm which optimizes acceleration and deceleration without causing unnecessary or undesirable conditions. The control system 80 is configured to control the operations of the OTV 10 during a dynamic vehicle test.

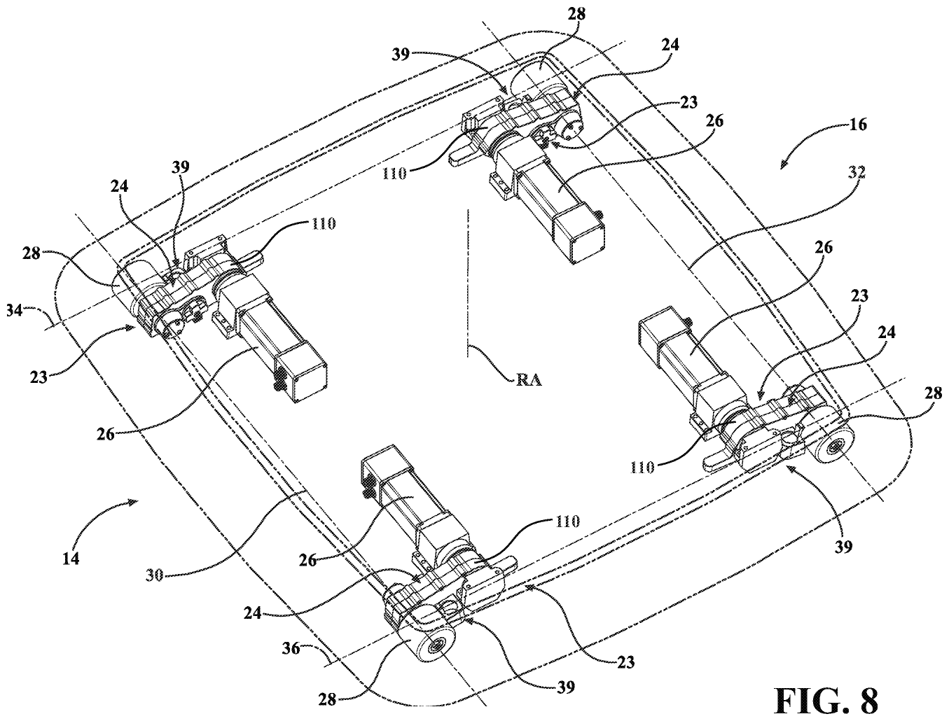

Turning to FIG. 8, the OTV 10 may include a first section 14 and a second section 16. In some examples, the first section 14 may be the front portion or the back portion of the OTV 10 and the second section 16 may be the other of the front portion or the back portion of the OTV 10. For purposes of the present disclosure, the first section 14 will refer to the “front” of the OTV 10 and the second section 16 will refer to the “back” of the OTV 10. Similarly, the OTV 10 may be referred as having two sides 34, 36 comprising a first side 34 and a second side 36. In some examples, the first side 34 may be the right side of the OTV 10 or the left side of the OTV 10, and the second side 36 is the other of the right side or the left side of the OTV 10. For purposes of the present disclosure, the first side 34 will be used to refer to the “right” side of the OTV 10 and the second side 36 will be used to refer to the “left” side of the OTV 10. In the present example, the OTV 10 may have two drive mechanisms 23 in the first section 14 and two drive mechanisms in the second section 16 forming axle arrangements 30, 32, as seen in FIG. 8.

The axle arrangements 30, 32 may comprise two drive mechanisms 23 in each of the first section 14 and second section 16 of the OTV 10. The axle arrangements 30, 32 may be arranged such that each of the drive wheels 28 of the two drive mechanisms 23 of the same section 14, 16 are aligned. In some examples, such as illustrated in FIG. 8, the first axle arrangement 30 includes two drive mechanisms 23 in the first section 14, and the second axle arrangement 32 includes the two drive mechanisms 23 in the second section 16. Each of the first axle arrangement 30 and the second axle arrangement 32 are shown with their respective drive wheels 28 aligned in FIG. 8. Each drive mechanism 23 is attached to the chassis 12 such that the drive wheels 28 are held in a fixed alignment. In the present example, each of the drive wheels 28 and drive mechanisms 23 are in fixed alignment, and thus, no traditional steering mechanism is present in the OTV 10. Rather, the control system 80 may utilize the separate electric motors 26 to create a torque vector to turn the OTV 10 to the desired trajectory. However, it is also contemplated that the OTV 10 may include a steering mechanism such as a rack and pinion steering mechanism or the like.

Each of the drive mechanisms 23 may include an electric motor 26. The electric motors 26 function to provide propulsion to the OTV 10 and/or function to assist in slowing down or stopping the OTV 10. In the examples of FIGS. 6-7, the OTV 10 includes four motors 26. Each electric motor 26 may include a motor housing and an output shaft. Each of the electric motors 26 may be independently powered and controlled. The electric motors 26 may be controlled separately by the control system 80. In other examples, each electric motor 26 includes a motor controller 27. In some examples, the motor controller 27 functions to determine and communicate one or more motor parameters between each of the electric motors 26 and the control system 80. As described above, the electric motors 26 may function as a steering system. For example, the electric motors 26 may be operatively connected with the transaxle 24 and control the steering of the OTV 10 by increasing and decreasing power output and direction of rotation of the drive wheels 28 through each transaxle 24. The electric motors 26 are part of the drive mechanisms 23 and connected with the transaxle 24, a suspension system 39, one or more power supplies (i.e., batteries 82), the drive wheels 28, or a combination thereof.

The drive mechanisms 23 may each include a transaxle 24 connecting the electric motor 26 with the drive wheel 28. The transaxle 24 functions to translate rotational movement from the output of each electric motor 26 into rotational movement of drive wheels 28 at a location away from the output shaft of the electric motors 26. In some examples, the transaxle 24 is a chain drive connecting the output of the electric motors 26 to drive wheel 38. The chain drive may function to transfer rotational movement from an output shaft of the electric motor 26 to power a wheel 28. Each transaxle 24 may include at least one means of transmission between the electric motor 26 output and the drive wheel 28. The transaxle 24 may include at least one chain, belt, band, the like, or a combination thereof for transferring rotational motion from the electric motor 26 to the drive wheel 28.

Each drive mechanism 23 may include one drive wheel 28 per transaxle 24. The drive wheels 28 may function to move the OTV 10 over a surface. As shown in FIGS. 5-8, the wheel(s) 28 are operatively attached to the chassis 12, with one wheel 28 on each pivot arm 110 (described in further detail below). Each of the drive wheels 28 may include a tire wrapped around its circumference. In some examples, the drive wheel 28 integrates the tire such that the wheel and the tire are unitary. The tires may function to provide traction on a surface. The tires may be made natural rubber, synthetic rubber, plastic, fabric, steel, polymers, or a combination thereof. The tires may be inflatable. The tires may be an airless design. The tires may be solid. The tires may be deformable. The tires may be a disposable item that may be replaced when worn out.

As generally described above, the wheel(s) 28 may be operatively attached to the chassis 12 (e.g., via the transaxles 24 and/or the pivot arm 110, described below). Turning to FIGS. 6-12, the OTV 10 includes the suspension system 39 which allows relative movement between each wheel 28 and the chassis 12. In other words, the suspension system 39 may function to allow relative movement between the chassis 12 and the discrepancies of the road as contacted by the wheel(s) 28, provide damping and/or impact absorption as the OTV 10 maneuvers over a surface.

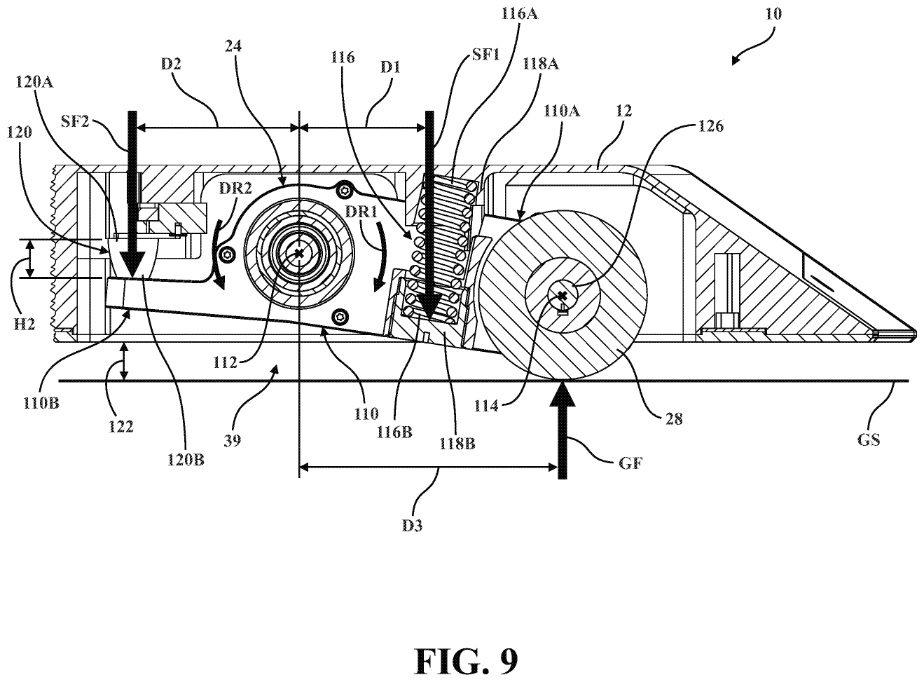

For ease of explanation, the suspension system 39 will be described herein with respect to one wheel 28. It should be appreciated that each wheel 28 may have its own suspension system 39. As best shown in FIGS. 9-12, a pivot arm 110 extends between a first portion 110A and a second portion 110B. The pivot arm 110 is pivotably mounted to the chassis 12 between the first portion 110A and the second portion 110B about a pivot axis 112. Here, the wheel 28 is rotatably mounted to the first portion 110A of the pivot arm 110 for rotation about a wheel axis 114. The components of the transaxle 24 (which function to convert rotational movement of the output shaft of each electric motor 26 into rotational movement of the respective drive wheels 28 at a location away from the output shaft of the electric motors 26) may be integrated within the pivot arm 110 to power the wheel 28 to rotate about the wheel axis 114.

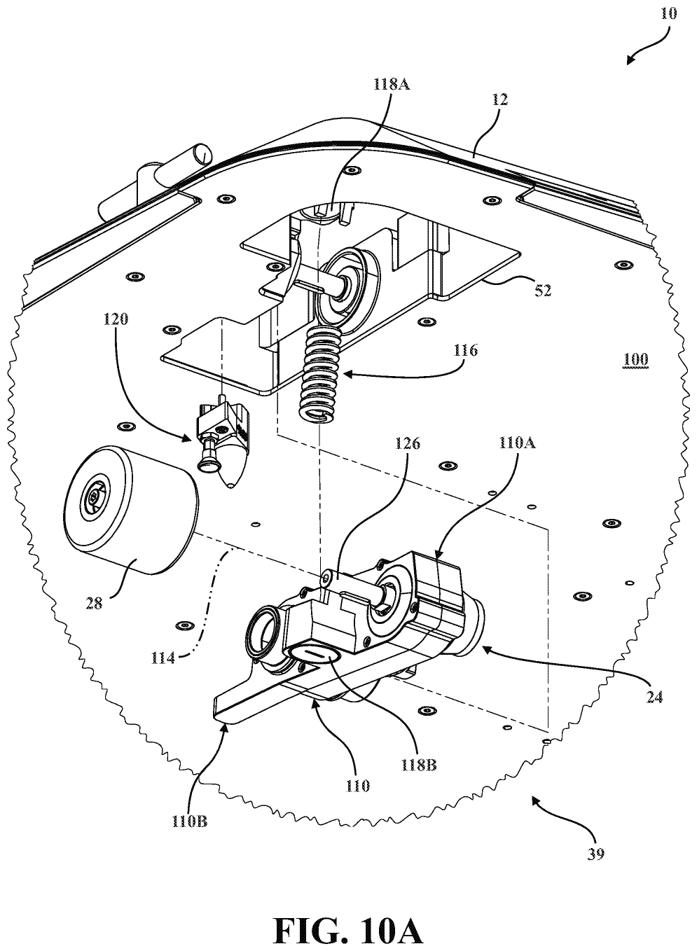

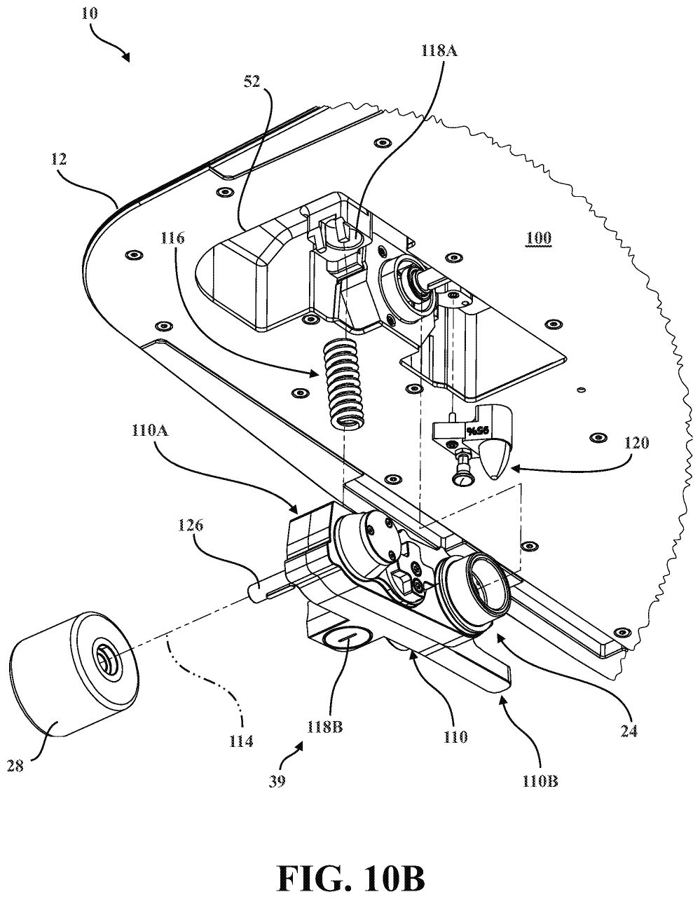

With continued reference to FIGS. 9-12, the suspension system 39 also includes a first biasing element 116. The first biasing element 116 is partially supported by the chassis 12 and arranged to engage the first portion 110A of the pivot arm 110 to provide a first suspension force SF1 in a first direction DR1 about the pivot axis 112. In some examples, referring to FIGS. 9 through 10B, the first biasing element 116 extends between a first end 116A coupled to the chassis 12 and a second end 116B coupled to the first portion 110A of the pivot arm 110. The first biasing element 116 may comprise a spring, shock, strut, damper, elastomeric damper, or the like. Accordingly, the chassis 12 may define a chassis seat 118A that at least partially receives/supports first end 116A of the first biasing element 116 relative to the chassis 12. Likewise, the pivot arm 110 may define a pivot arm seat 118B that at least partially receives/supports second end 116B of the first biasing element 116 relative to the first portion 110A of the pivot arm 110. The first biasing element 116 has a first spring rate K1. In some examples, the first spring rate K1 is a linear spring rate, but in other examples the first spring rate K1 may be a non-linear spring rate.

The suspension system 39 also includes a second biasing element 120. The second biasing element 120 is at least partially supported by the chassis 12 and arranged to engage the second portion 110B of the pivot arm 110 to provide a second suspension force SF2 a second direction DR2 about the pivot axis (opposite first direction DR1). In some examples, referring to FIGS. 9 through 10B, the second biasing element 120 extends between a first end 120A operatively attached to the chassis 12 and a second end 120B arranged to abut the second portion 110B of the pivot arm 110. The second biasing element 120 may be removably or pivotably coupled to the chassis 12 to allow the second biasing element 120 to be moved away from the second portion 110B of the pivot arm 110 to allow the suspension system 39 to move to a service state SS (described in further detail below). The second biasing element 120 may comprise a spring, shock, strut, damper, elastomeric damper, or the like. The second biasing element 120 has a second spring rate K2, which is different than the first spring rate K1 of the first biasing element 116. For example, the second spring rate K2 may be progressive (e.g., exponential in relation to compression of the second biasing element 120), but in other examples the second spring rate K1 may be a linear spring rate.

FIGS. 10A and 10B each show exploded perspective views of the suspension system 39 according to the present disclosure. As shown in FIGS. 10A and 10B, the suspension system may be at least partially disposed within the pockets 52 of the bottom cover 100. In this illustrated example, the pivot axis 112 and the output shaft of the motor 26 are coaxial such that the pivot arm rotates relative to the output shaft of the motor 26. Here, the components of the transaxle 24 may be disposed within the pivot arm 110 such that the first portion 110A of the pivot arm 110 includes a wheel shaft 126 for supporting the wheel 28 for rotation about the wheel axis 114, as driven by the motor 26. The second portion 110B of the pivot arm 110 is opposite the first portion 110A such that the second portion 110B is arranged for engagement with the second biasing element 120. The first biasing element 116, on the other hand, is arranged between the chassis 12 and the first portion 110A of the pivot arm 110.

As best shown in FIG. 9, the first biasing element 116 may be spaced from the pivot axis 112 at a first distance D1. Accordingly, the pivot arm 110 may experience a first biasing moment BM1 about the pivot axis 112 in the first direction DR1. The first biasing moment BM1 is the product of the first suspension force SF1 and the first distance D1. With continued reference to FIG. 9, the second biasing element 120 may be spaced from the pivot axis 112 at a second distance D2. Accordingly, the pivot arm 110 may experience a second biasing moment BM2 about the pivot axis 112 in the second direction DR2. The second biasing moment BM2 is the product of the second suspension force SF2 and the second distance D2. Still referring to FIG. 9, the wheel 28 may experience a ground force due GF to contacting a ground surface GS. The wheel 28 may be spaced from the pivot axis 112 at a third distance D3. Accordingly, the pivot arm 110 may experience a ground force moment GFM about the pivot axis 112 in the second direction DR2. The ground force moment GFM is the product of the ground force GF and the third distance D3. In some examples, such as illustrated in FIG. 9, the third distance D3 is greater than the first distance D1 (in other words, the wheel 28 is further from the pivot axis 112 than the first biasing element 116). Of course, it should be appreciated that in other examples, the third distance D3 may be equal to or less than the first distance D1.

With continued reference to FIG. 9, the sum of the second biasing moment BM2 and the ground force moment GFM about the pivot axis 112 may be equal to the first biasing moment BM1 such that the suspension system 39 supports the chassis 12 about the ground surface GS at an operating height 122. In other words, the forces experienced by the pivot arm 110 about the pivot axis 112 may be quantified according to Equations 1 and 2 below:

$$BM 2 + GFM = BM 1 \qquad ( 1 )$$

$$( SF 2 * D 2 ) + ( GF * D 3 ) = ( SF 1 * D 1 ) \qquad ( 2 )$$

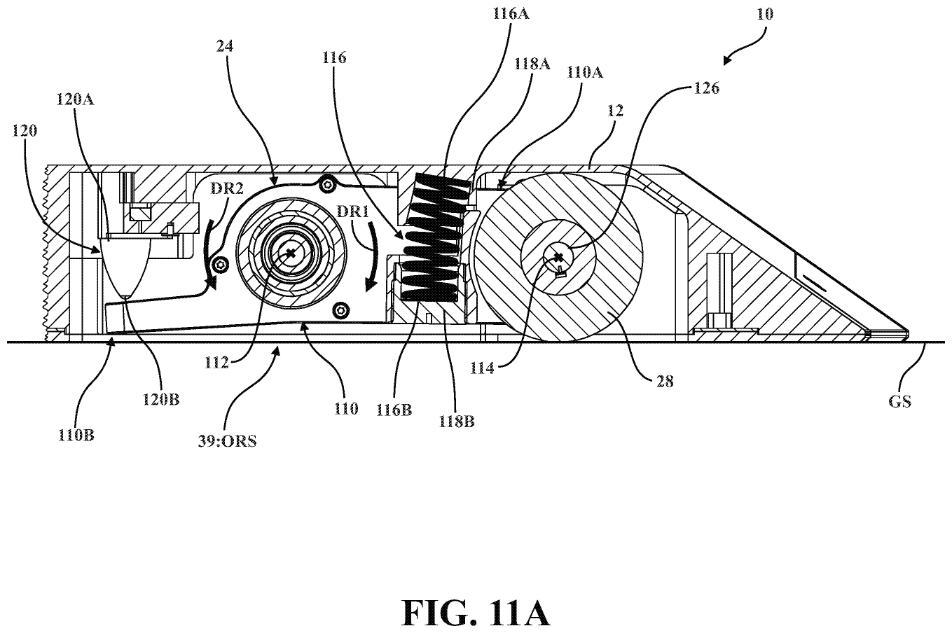

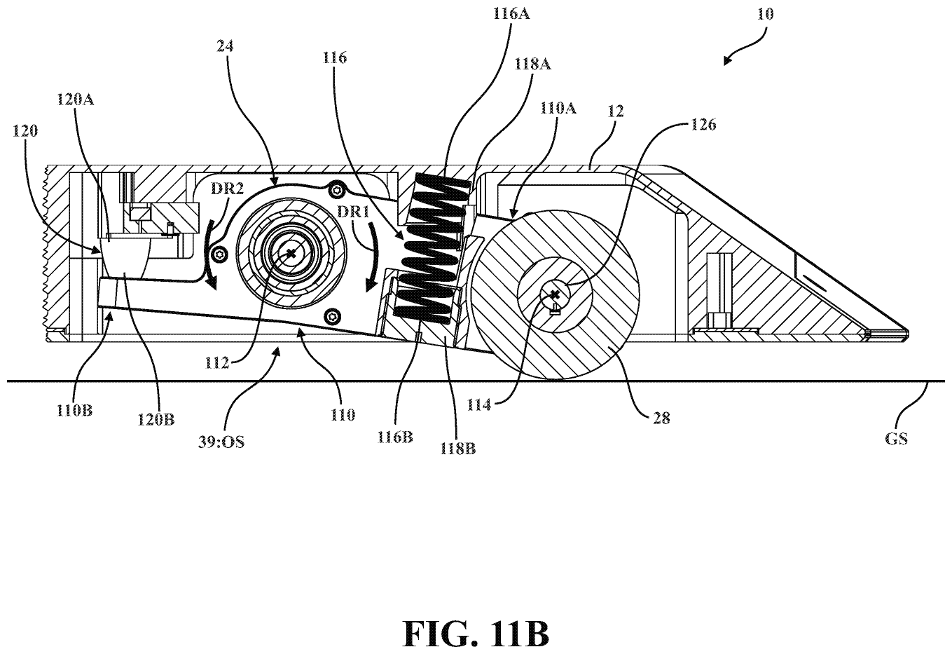

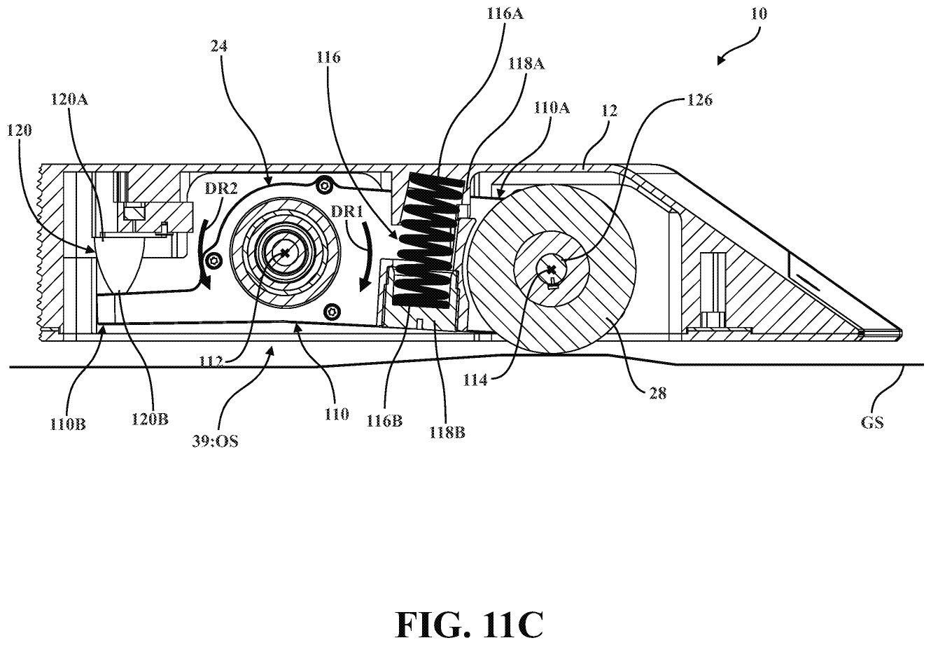

Referring to FIGS. 11A through 11C, the suspension system 39 may be operable for movement between a plurality of suspension states. The plurality of suspension states may include an operating state OS. As shown in FIGS. 11B, in the operating state OS, the wheel 28 is partially spaced below the chassis 12 to support the chassis above the ground surface at the operating height 122. Referring to FIG. 11C, it should be appreciated that the chassis 12 may deviate from the operating height 122 (i.e., the variable operating height 122) in the operating state OS based on conditions experienced by the OTV 10 traveling along the ground surface. In other words, the suspension system 39 does not rigidly hold the chassis 12 at the operating height 122. Instead, the operating height 122 is defined where the suspension system 39 is in a steady state (i.e., not subject to dynamic forces) and variable when subject to dynamic forces to absorb/damp impacts of the chassis 12 relative to the ground surface GS, such as shown in FIG. 11C. As shown in FIG. 9, it should also be appreciated that the second biasing element 120 may have a second height H2. The operating height 122 may be defined by the second height H2 (particularly because the second biasing element 120 delimits rotation of the pivot arm 110 about the pivot axis 112). In other words, the operating height 122 may be adjusted based on a predetermined second height H2. In some examples, the second height H2 is defined such that the operating height 122 is 10 mm.

Referring to FIG. 11A, the plurality of suspension states also includes an overrun state ORS. In the overrun state ORS, the wheel 28 moves toward the chassis 12 such that the chassis 12 contacts the ground surface GS to permit the OTV 10 to be overrun by a vehicle. Still referring to FIG. 11A, the pivot arm 110 (particularly the second portion 110B) may be configured to disconnect from the second biasing element 120 in response to the suspension system 39 moving to the overrun state ORS. Accordingly, in the overrun state ORS, the second suspension force SF2 is zero. It should be appreciated that the pivot arm 110 (particularly the second portion 110B) may disconnect from the second biasing element 120 as the suspension system 39 moves toward the overrun state ORS. For example, the pivot arm 110 may disconnect from the second biasing element 120 where the operating height 122 is less than 5 mm. Of course, it is contemplated that the pivot arm 110 may disconnect from the second biasing element 120 at other suitable operating height thresholds.

The suspension system 39 of the OTV needs to have both good damping characteristics when in the operating state OS, but also needs to be able to withstand the intense load of the overrun state ORS. Here, the arrangement of the first biasing element 116 and the second biasing element 120 relative to the pivot axis 112, as well as the differing spring rates (K1 and K2) of the first biasing element 116 and the second biasing element 120, influence the behavior of the suspension system 39 during operation of the OTV 10 to achieve these desired performance characteristics. More specifically, the first biasing element 116 may be suited to allow for over-runability (e.g., the first biasing element 116 may be durable enough to withstand the load of the OTV 10 being overrun, and the first spring rate K1 may be high enough to restore the OTV 10 back to the operating height 122 after the OTV 10 has been overrun), while the second biasing element 120 may be suited to provide damping in the operating state OS (e.g., the second biasing element 120 may not be suited for over-runability, but the second spring rate K2 may be configured to provide the desired damping). Thus, as described above, the second biasing element 120 may only be engaged with the pivot arm 110 when the suspension system 39 is in the operating state OS to damp motion of the pivot arm 110 relative to the chassis 12. However, as the suspension system 39 moves toward the overrun state ORS, since the second biasing element 120 is arranged on the other side of the pivot axis 112 as the first biasing element 116 and the wheel 28, the second biasing element 120 may disconnect from the pivot arm 110 such that only the first biasing element 116 is engaged with the pivot arm 110 to control motion of the pivot arm 110 relative to the chassis 12. Thus, the suspension system 39 according to the present disclosure can achieve the desired damping characteristics without subjecting the second biasing element 120 to the intense forces of the overrun state ORS.

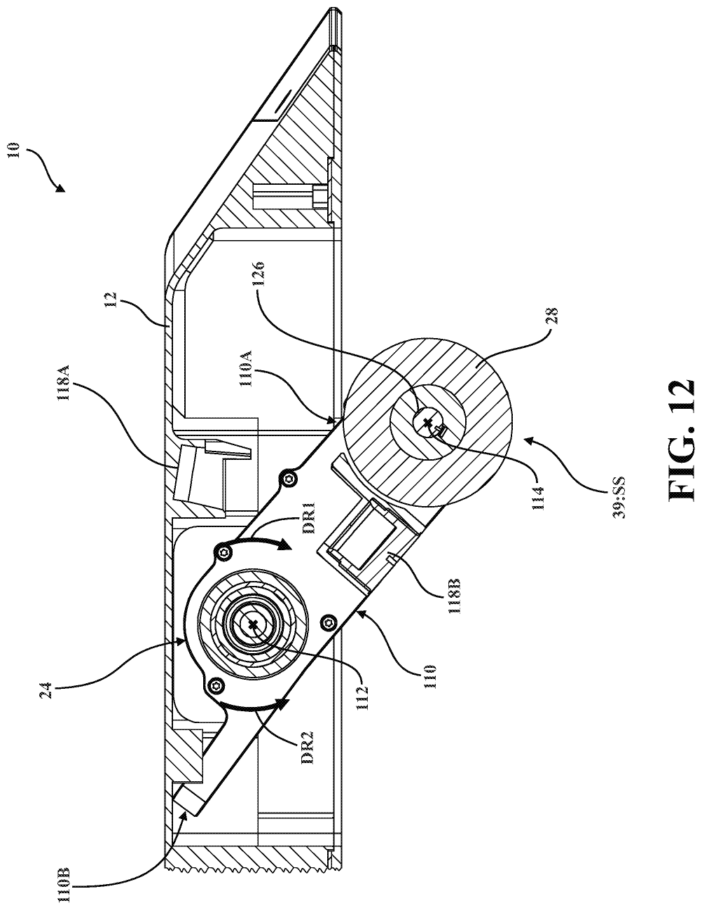

Referring to FIG. 12, the plurality of suspension states may further include a service state SS. In the service state SS, the second biasing element 120 is at least partially disconnected from the chassis 12. For example, the second biasing element 120 may be configured to pivot away from the pivot arm 110 to allow the pivot arm 110 to rotate further relative to the chassis 12 without the second portion 110B of the pivot arm 110 engaging the second biasing element 120, or the second biasing element 120 may be removed from the chassis 12 altogether (here, FIG. 12 illustrates the second biasing element 120 removed from the chassis 12). Accordingly, the pivot arm 110 may be rotated in the first direction D1 such that the wheel 28 is spaced from the chassis 12 to permit the wheel 28 to be removed from the pivot arm 110 so that service may be performed on the wheel 28, transaxle 24, chain/belt, sprocket, output shaft of the motor 26, or a combination thereof.

Several examples have been discussed in the foregoing description. However, the examples discussed herein are not intended to be exhaustive or limit the invention to any particular form. The terminology that has been used is intended to be in the nature of words of description rather than of limitation. Many modifications and variations are possible in light of the above teachings and the invention may be practiced otherwise than as specifically described.

What is claimed is:

1. An overrunable test vehicle configured to carry a soft target, the overrunable test vehicle comprising:
a chassis;
a wheel operatively attached to said chassis; and
a suspension system to allow relative movement between said wheel and said chassis with said suspension system comprising:
a pivot arm extending between a first portion and a second portion with said pivot arm pivotally mounted to said chassis between said first and second portions about a pivot axis, and said wheel rotatably mounted to said first portion about a wheel axis;
a first biasing element having a first spring rate, with said first biasing element partially supported by said chassis and arranged to engage said first portion of said pivot arm to provide a first suspension force in a first direction about said pivot axis; and
a second biasing element having a second spring rate, different than said first spring rate, with said second biasing element at least partially supported by said chassis and arranged to engage said second portion of said pivot arm to provide a second suspension force in a second direction about said pivot axis, opposite said first direction.

2. The overrunable test vehicle according to claim 1, wherein said first biasing element is spaced from said pivot axis at a first distance such that said pivot arm experiences a first biasing moment about said pivot axis in said first direction, wherein said first biasing moment is the product of said first suspension force and said first distance;
wherein said second biasing element is spaced from said pivot axis at a second distance such that said pivot arm experiences a second biasing moment about said pivot axis in said second direction, wherein said second biasing moment is the product of said second suspension force and said second distance; and
wherein said wheel experiences a ground force due to contacting a ground surface, and said wheel is spaced from said pivot axis at a third distance such that said pivot arm experiences a ground force moment about said pivot axis in said second direction, wherein the ground force moment is the product of said ground force and said third distance.

3. The overrunable test vehicle according to claim 2, wherein the sum of said second biasing moment and the ground force moment about said pivot axis is equal to said first biasing moment about said pivot axis such that said suspension system supports said chassis above the ground surface at a variable operating height.

4. The overrunable test vehicle according to claim 2, wherein said third distance is greater than said first distance.

5. The overrunable test vehicle according to claim 1, wherein said suspension system is operable for movement between a plurality of suspension states including:
an operating state where said wheel is partially spaced below said chassis such that said wheel contacts a ground surface to support said chassis above the ground surface at a variable operating height; and
an overrun state where said wheel moves toward said chassis such that said chassis contacts the ground surface to permit said overrunable test vehicle to be overrun by a vehicle.

6. The overrunable test vehicle according to claim 5, wherein said second biasing element has a second height, and wherein said variable operating height of said chassis relative to the ground surface is defined by said second height.

7. The overrunable test vehicle according to claim 6, wherein said variable operating height is 10 mm based on a predetermined second height.

8. The overrunable test vehicle according to claim 5, wherein said first biasing element is spaced from said pivot axis at a first distance such that said pivot arm experiences a first biasing moment about said pivot axis in said first direction, wherein said first biasing moment is the product of said first suspension force and said first distance;
wherein said second biasing element is spaced from said pivot axis at a second distance such that said pivot arm experiences a second biasing moment about said pivot axis in said second direction, wherein said second biasing moment is the product of said second suspension force and said second distance; and
wherein said wheel experiences a ground force from the ground surface and said wheel is spaced from said pivot axis at a third distance such that said pivot arm experiences a ground force moment about said pivot axis in said second direction, wherein the ground force moment is the product of said ground force and said third distance.

9. The overrunable test vehicle according to claim 8, wherein said third distance is greater than said first distance.

10. The overrunable test vehicle according to claim 8, wherein the sum of said second biasing moment and the ground force moment about said pivot axis is equal to said first biasing moment about said pivot axis such that said suspension system supports said chassis above the ground surface at a variable operating height.

11. The overrunable test vehicle according to claim 10, wherein said first spring rate of said first biasing element is linear.

12. The overrunable test vehicle according to claim 11, wherein said second spring rate of said second biasing element is progressive.

13. The overrunable test vehicle according to claim 5, wherein said pivot arm is configured to disconnect from said second biasing element in response to said suspension system moving to said overrun state such that said second suspension force equals zero where said suspension system is in said overrun state.

14. The overrunable test vehicle according to claim 13, wherein said second biasing element is disconnected from said pivot arm where the variable operating height is less than 5 mm.

15. The overrunable test vehicle according to claim 5, wherein said plurality of suspension states further includes a service state where said second biasing element is at least partially disconnected from said chassis and said pivot arm is rotated in said first direction such that said wheel is spaced from said chassis to permit said wheel to be removed from said pivot arm.

16. The overrunable test vehicle according to claim 1, wherein said first spring rate of said first biasing element is linear.

17. The overrunable test vehicle according to claim 1, wherein said second spring rate of said second biasing element is progressive.

18. The overrunable test vehicle according to claim 1, wherein said first biasing element is a spring.

19. The overrunable test vehicle according to claim 1, wherein said second biasing element is an elastomeric damper.
